(19) United States
(12) Patent Application Publication
(10) Pub. No.: US 2005/0105574 A1
(43) Pub. Date: May 19, 2005

(54) Laser driver for optical communication network

(76) Inventors: Xin M. Wu, Alhambra, CA (US); Allen M. Earman, Santa Clara, CA (US); Yen-Ping Ho, San Jose, CA (US)

Correspondence Address: TROP PRUNER & HU, PC, 8554 KATY FREEWAY, SUITE 100, HOUSTON, TX, 77024, US

(21) Appl. No.: 10/713,380

(22) Filed: Nov. 14, 2003

(51) Int. Cl. H01S 3/00

(52) U.S. Cl. 372/38.07; 372/38.02; 372/38.04

(57) ABSTRACT

A transistor, such as a FET or bipolar transistor, may be gate or base coupled to a laser driver output stage to receive a varying voltage from a driver output stage. The transistor converts the varying voltage to a varying current. The transistor, in series with the laser, may be coupled to a supply voltage on one side and ground on the other side. Thus, the current supplied to the laser diode is a function of the drive supplied to the transistor's base or gate.

### BACKGROUND

This invention relates generally to optical communication networks. In particular, in some embodiments, it relates to a laser modulation scheme.

Typically, an optical communication network uses a light source in the form of a laser to produce optical signals that are transmitted over an optical path. The optical path may, for example, be a fiber optic cable. Typically, those signals may be wavelength division multiplexed so that a large number of different signals of distinct wavelengths may be transmitted over the same fiber.

A transmitter for an optical communication network generally includes a laser diode and a driver for that diode. The laser driver modulates the laser current and, therefore, the laser light output, in accordance with the signal that is to be transmitted.

A direct modulated laser may use a laser driver that includes an output termination and a damping resistor connected in series with the laser diode. This type of driver scheme may have a number of disadvantages. A relatively powerful driver, with higher voltage/current output swings, may be used since the same modulation current goes through both the laser diode and the damping resistor. As a result, power consumption is relatively high. In order to produce such high output swings, relatively expensive gallium arsenide drivers may be utilized. Moreover, the higher power driver may thermally impact the laser, such that the driver may need to be placed far away from the laser diode, resulting in transmitter radio frequency performance degradation.

Thus, there is a need for better ways to provide laser modulation in optical communication systems.

### BRIEF DESCRIPTION OF THE DRAWINGS

FIG. 1 is a schematic depiction of one embodiment of the present invention;

FIG. 2 is a schematic depiction of another embodiment of the present invention;

FIG. 3 is a schematic depiction of another embodiment of the present invention;

FIG. 4 is a schematic depiction of another embodiment of the present invention;

FIG. 5 is a schematic depiction of another embodiment of the present invention;

FIG. 6 is a schematic depiction of another embodiment of the present invention; and

FIG. 7 is a system depiction of one embodiment of the present invention.

### DETAILED DESCRIPTION

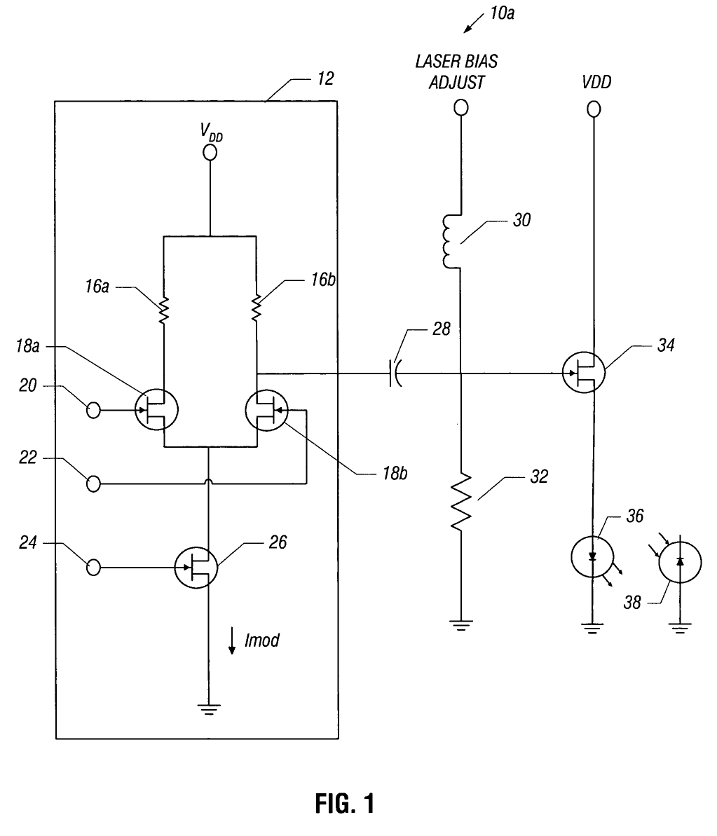

Referring to FIG. 1, a laser driver 10a, in accordance with one embodiment of the present invention, includes a driver output stage 12. The driver output stage allows adjustment of the modulation through a terminal 24 and receipt of the differentially driven data and data complement signals through terminals 20 and 22.

A differential circuit includes a pair of resistors 16a and 16b and a pair of transistors 18a and 18b. The differential circuit pulls the output of the stage 12 down based on the signals on the gates of transistor 18. The transistor 18b receives the data complement input while the transistor 18a receives the data input. A transistor 26 receives the current control input which controls the current I mod as indicated.

The output of the driver output stage 12 is passed through a capacitor 28 for the AC path of the transistor 34. A laser bias adjustment voltage-may be applied through an inductor 30 for the DC path of the transistor 34. A shunt matching resistor 32 may be used as well.

The output from the output stage 12 controls the potential on the gate of a field effect transistor 34 in one embodiment of the present invention. The transistor 34 is coupled between a supply voltage and ground, in series with the laser diode 36. The single transistor 34 acts as a simple, low cost, single stage amplifier to increase the modulation current. The gate voltage on the transistor 34 controls the amount of current applied to the laser diode 36.

A monitor photodiode 38 may be used to monitor the light output of the laser diode 36. The signal from the diode 38 may be used to control the driver 10a.

The laser diode 36 communicates with a laser diode receiver across an optical network. In one embodiment of the present invention, the laser driver 10a may be implemented with field effect transistors. As one example, a pseudomorphic high electron mobility transistor (PHEMT) may be used.

The laser modulation current is controlled by the voltage on the gate of the transistor 34, which in turn is controlled by the driver output stage 12 voltage. The voltage swings at the gate do not have to be very large in order to get enough modulation current through the laser diode 36 in some embodiments. Thus, a relatively powerful output stage 12 may not be needed. As a result, smaller power supplies with lower voltage levels may be used for the entire driver 10a in some embodiments. The use of lower supply voltages may reduce the total power consumption. Moreover, because the transistor 34 is a lower power device, it can be placed next to the laser diode 36 without causing significant thermal impact on the laser diode 36 in some embodiments.

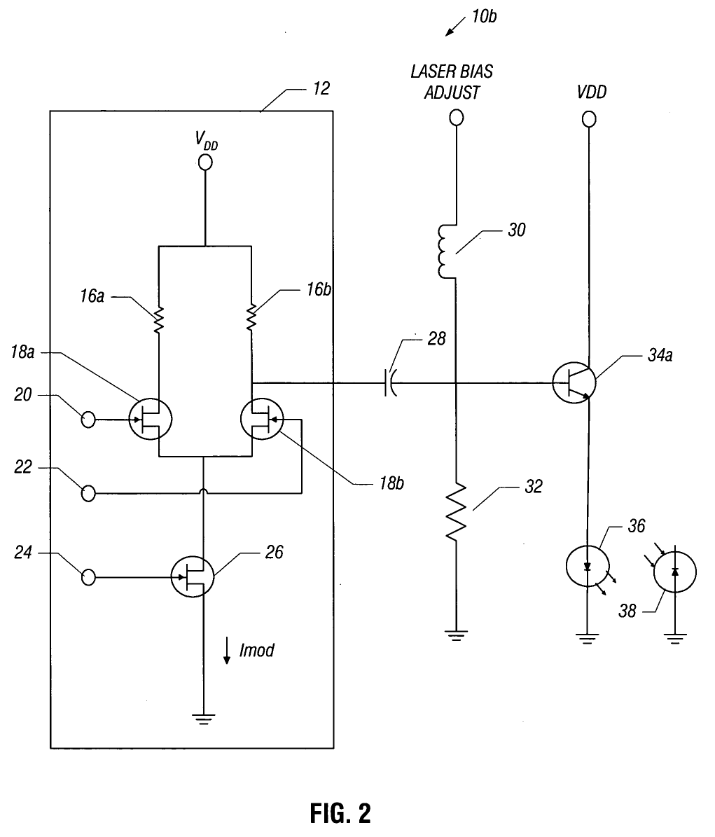

Referring next to FIG. 2, the laser driver 10b is similar to the laser driver 10a shown in FIG. 1. However, in this case, a transistor 34a in the form of a bipolar transistor is utilized. The voltage on the base of the bipolar transistor 34a controls the amount of current applied to the laser diode 36.

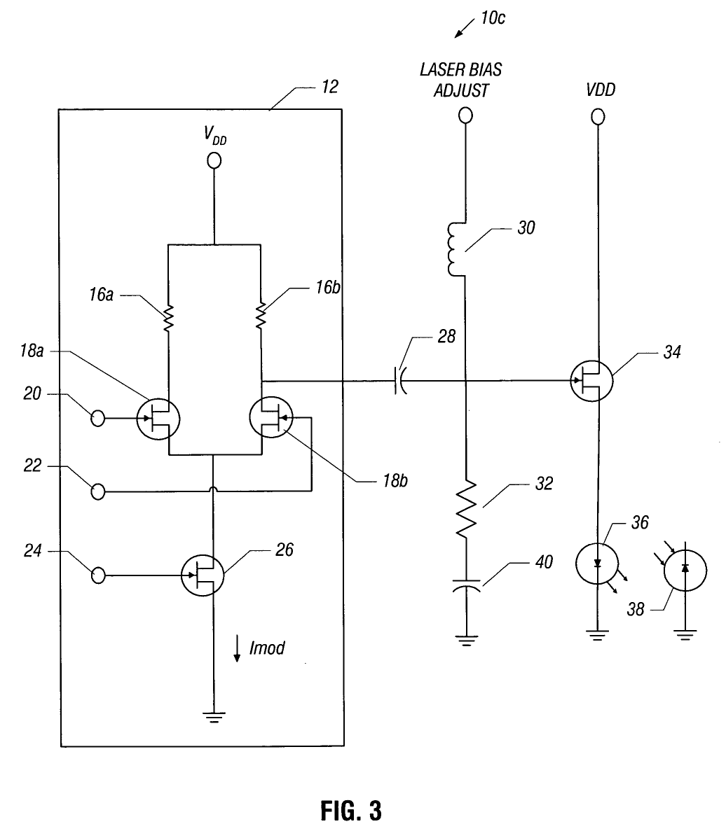

Turning next to FIG. 3, the laser driver 10c is similar to the driver 10a shown in FIG. 1. However, in this example, an AC coupled matching resistor 32 includes a capacitor 40. The AC coupled matching resistor 32 may have essentially no DC power dissipation in some embodiments. As a result, the AC coupled matching resistor 32 reduces the overall transmitter power dissipation.

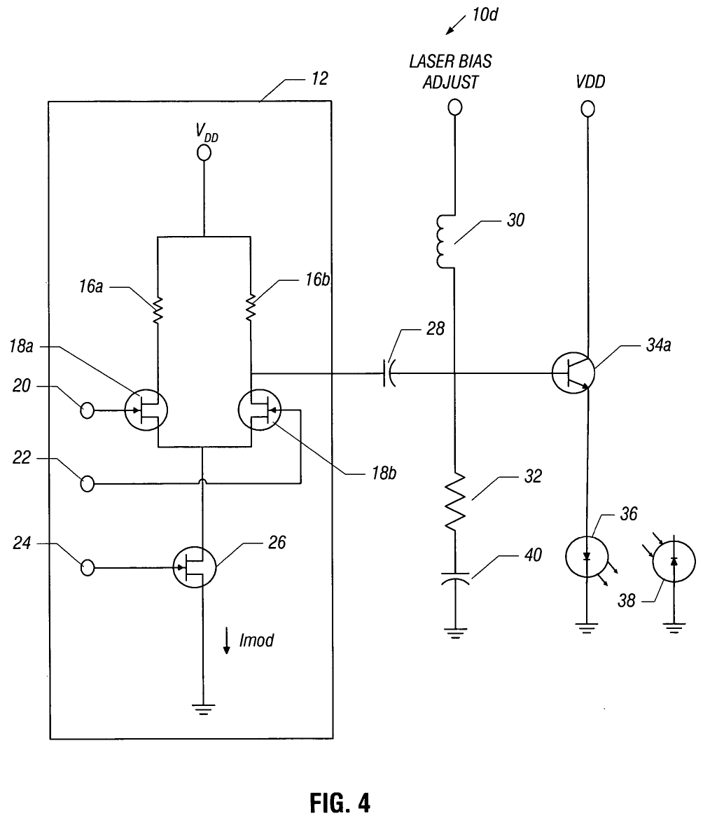

Referring next to FIG. 4, a driver 10d, similar to the driver 10c shown in FIG. 3, uses a bipolar transistor 34a, in place of a field effect transistor 34.

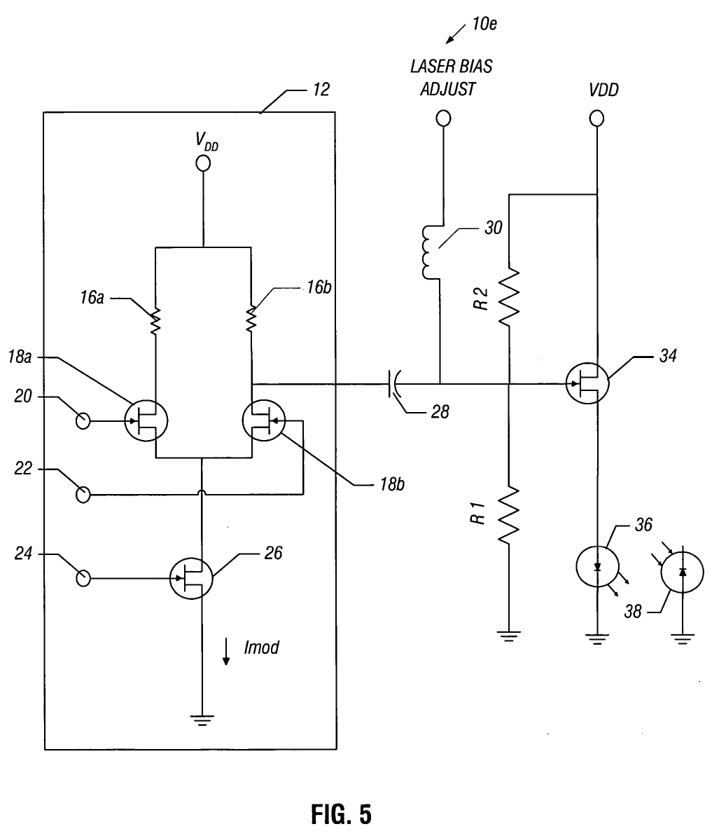

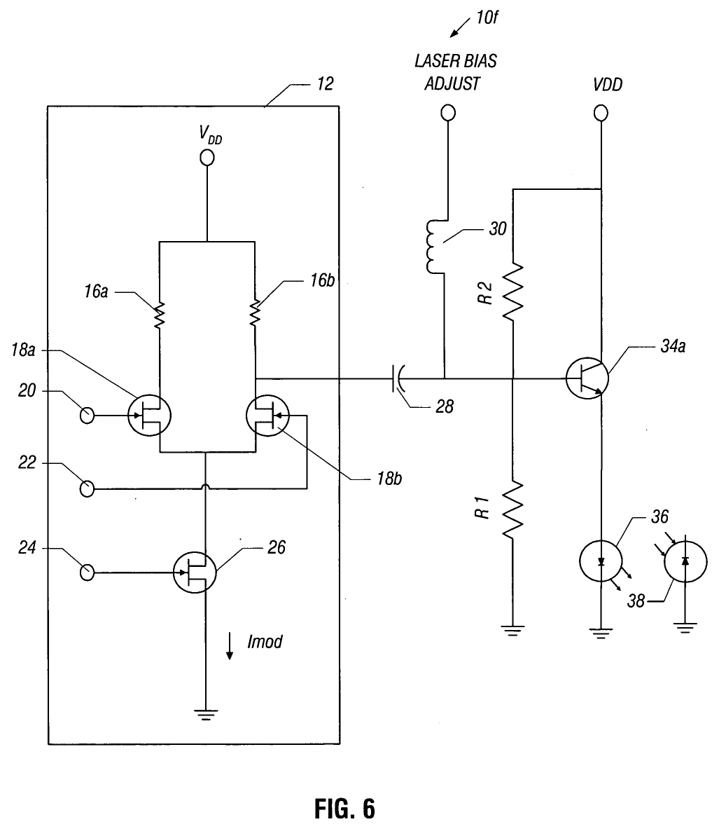

Referring to FIG. 5, the laser driver 10e is otherwise similar to the laser driver 10a except that a pair of matching resistors R1 and R2 are utilized. In effect, the matching resistor 32 from the previous embodiments is split in two. The ratio of the resistance of the resistor R1 to that of the resistor R2 is equal to the matching resistance. If the resistance of the resistor R1 is much greater than the matching resistance and the resistance of the resistor R2 is much greater than the matching resistance, the power dissipation of both R1 and R2 may be reduced. FIG. 6 shows a similar arrangement but using a bipolar transistor 34a in the laser driver 10f.

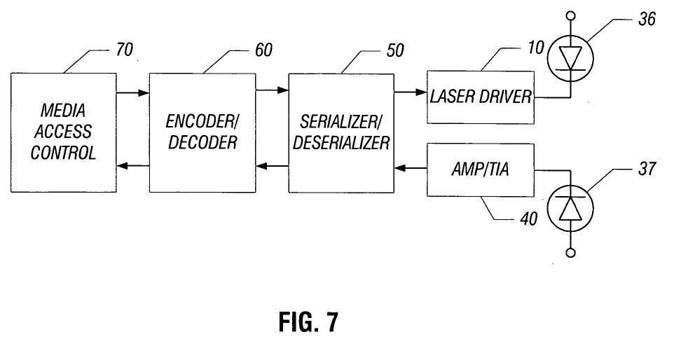

Finally, referring to FIG. 7, a network interface, according to one embodiment of the present invention, includes a media access control 70 coupled to an encoder/decoder 60 and a serializer/deserializer 50 in one embodiment. The serializer/deserializer 50 may be coupled, on the transmitter side, to the laser driver 10, which may be any of the embodiments illustrated herein. The driver 10 in turn is coupled to the transmitting laser diode 36.

On the receiver side, the receiving photo diode 37 is coupled to a limiting amplifier/transimpedance amplifier 40, which in turn may be coupled to the serializer/deserializer 50.

On the transmitter side, digital data may be provided from the media access control module 70 to the encoding/decoding module 60, where the digital data may be encoded into a format that is advantageous for conversion into optical signals. If the digital data is already in the proper form, processing by the encoder/decoder 60 may be unnecessary. Sometimes, the encoded digital data needs to be serialized or deserialized. In such case, the encoded digital data may be fed to the serializer/deserializer 50. The output from the serializer/deserializer 50 may be fed to the laser driver 10 that may drive the laser diode 36 as described previously. Optical energy may be created and optical signals may be provided from the interface to a fiber optic line (not shown) in one embodiment of the present invention.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
providing current to a laser diode of an optical communication system using a transistor coupled in series with said laser diode between a power supply voltage and ground.

2. The method of claim 1 including providing a differential output stage coupled to drive said transistor.

3. The method of claim 2 including providing a differential output stage coupled to gate drive said transistor.

4. The method of claim 2 including providing a differential output stage to base drive said transistor.

5. The method of claim 1 including providing an AC coupled matching resistor.

6. The method of claim 1 including providing parallel matching resistors coupled to said transistor.

7. A method comprising:
forming a direct modulation laser driver including a transistor coupled between a power supply and a laser diode; and
coupling said transistor to be driven by a differential output stage.

8. The method of claim 7 wherein forming a direct modulation laser driver including a transistor includes forming a driver including a field effect transistor having its gate coupled to said differential output stage.

9. The method of claim 7 wherein forming a direct modulation laser driver including a transistor includes forming a driver including a bipolar transistor having its base coupled to said differential output stage.

10. The method of claim 7 including AC coupling a shunt resistor to said transistor.

11. The method of claim 7 including providing a pair of parallel shunt resistors coupled to said transistor.

12. A driver for a direct modulation laser comprising:
a differential output stage;
a transistor driven by said differential output stage, said transistor coupled between a power supply and ground; and
a laser diode coupled in series with said transistor.

13. The driver of claim 12 wherein said transistor is a field effect transistor having its gate coupled to said differential output stage.

14. The driver of claim 12 wherein said transistor is a bipolar transistor having a base coupled to said differential output stage.

15. The driver of claim 12 including a pair of parallel shunt resistors coupled to said transistor.

16. The driver of claim 12 including a shunt resistor AC coupled to said transistor.

17. A system comprising:
a media access control; and
a laser driver coupled to said media access control, said laser driver including a differential output stage, a transistor driver by said differential output stage, said transistor coupled between a power supply and ground, and a laser diode coupled in series with said transistor.

18. The system of claim 17 wherein said transistor is a field effect transistor having its gate coupled to said differential output stage.

19. The system of claim 17 wherein said transistor is a bipolar transistor having a base coupled to said differential output stage.

20. The system of claim 17 including a pair of parallel shunt resistors coupled to said transistor.

21. The system of claim 17 including a shunt resistor AC coupled to said transistor.
